(19) United States
(12) Patent Application Publication
(10) Pub. No.: US 2003/0194077 A1
(43) Pub. Date: Oct. 16, 2003

(54) Bridge between multiple telephone service providers

(76) Inventor: Blaine Edward Ramey, Indianapolis, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/123,590

(22) Filed: Apr. 15, 2002

(51) Int. Cl. H04M 7/00

(52) U.S. Cl. 379/221.01

(57) ABSTRACT

A bridge device for telephony services includes a system processor, which is coupled between at least two heterogeneous telephone networks. The system processor includes information for selecting one of the heterogeneous networks in accordance with criteria. A switching device is controlled by the system processor to dynamically select one of the at least two heterogeneous telephone networks to provide service to a subscriber by causing a connection to be made to the selected telephone network.

### FIELD OF THE INVENTION

The present invention generally relates to network communications and, more particularly, to a system and method for providing a bridge between service providers to permit a subscriber to dynamically select a service provider for a particular type of service.

### BACKGROUND OF THE INVENTION

Emerging alternative telephone networks use hybrid fiber-coax (HFC) cable systems, digital subscriber line (DSL) or wireless systems to provide telephone service to the subscriber's residence or place of business. These systems, generally termed Competitive Local Exchange Carriers (CLECs), provide services, which are equivalent to those now available from Regional Bell Operating Companies (RBOCs) over conventional Plain Old Telephone Service (POTS) copper-pair wiring. It would be advantageous in many situations to provide a system in which a customer could choose to subscribe to both a RBOC and a CLEC, possibly in order to minimize the time the customer loses telephone service due to power, equipment or network outages, or to optimize the service offerings against pricing from multiple providers. It would therefore be advantageous to provide a device or system, which acts as a collection and distribution point for services available from multiple service providers.

In addition, existing private branch exchange (PBX) devices permit conferencing between local endpoints and endpoints connected through the Public Switched Telephone System (PSTN), and allow an incoming call to be routed to individual or multiple local endpoint devices. PBXs generally provide multiple local foreign exchange station (FXS) ports for local endpoints and a digital trunk connection such as a T1 connection to the PSTN central office. They may also provide foreign exchange office (FXO) connections for services such as, e.g., Centrex™. T1 and FXO services would not both be present from different service providers, but may instead be provided from the same service provider.

Existing packet telephony gateways accept a call or message from a data network and convert it to analog form for a conventional telephone, and also perform the inverse conversion. Gateways do not provide programmable collection/distribution functions for multiple networks

It would be advantageous to provide a system and method for dynamically selecting a particular service provider for each individual service needed by a subscriber. Therefore, a need exists for a system and method which permits a subscriber to dynamically choose a service provider for each of several different telephony services, including but not limited to local calling, long distance calling, caller ID, voice mail, etc.

### SUMMARY OF THE INVENTION

A bridge device for telephony services includes a system processor, which is coupled between at least two heterogeneous telephone networks. The system processor includes information for selecting one of the heterogeneous networks in accordance with criteria. A switching device is controlled by the system processor to dynamically select one of the at least two heterogeneous telephone networks to provide service to a subscriber by causing a connection to be made to the selected telephone network.

Another bridge device for telephony services includes a system processor, which is coupled between at least two heterogeneous telephone networks. One of the at least two heterogeneous telephone networks processes digital signals. The system processor includes information for selecting one of the heterogeneous networks in accordance with criteria. The switching processor includes a switching program controlled by the system processor to dynamically select one of the at least two heterogeneous telephone networks to provide service to a subscriber by causing a connection to be made to the selected telephone network.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 is a schematic diagram showing a bridge device between an analog cellular network and a POTS network in accordance with one embodiment of the present invention;

FIG. 2 is a schematic diagram showing an analog crosspoint in greater detail in accordance with one embodiment of the present invention;

FIG. 3 is a schematic diagram showing a bridge device between a cable network and a POTS network in accordance with another embodiment of the present invention; and

FIG. 4 is a schematic diagram showing a TDM backbone in greater detail in accordance with another embodiment of the present invention.

It should be understood that the drawings are for purposes of illustrating the concepts of the invention and are not necessarily the only possible configuration for illustrating the invention.

### DETAILED DESCRIPTION OF THE INVENTION

The present invention provides a system and method which permits a subscriber to dynamically choose a service provider for each of several different telephony services, including but not limited to local calling, long distance calling, caller ID, voice mail, etc. The present invention provides a device/system, which provides interoperability of multiple telephone service providers. For example, one provider may be a Regional Bell Operating Company (RBOC) using conventional Plain Old Telephone Service (POTS) and another service provider may include a service based on cable-modem telephony or wireless telephone. Besides acting as a common termination point for calls originating in either system, the present invention may regenerate calls and data transmitted on one system for use on the other. Subscriber cost-saving features may also be provided by automatically selecting the lowest-cost provider for a particular dialed call.

Emerging alternative telephone networks may employ hybrid fiber-coax (HFC) cable systems, digital subscriber line (DSL) or wireless systems to provide telephone service to the subscriber's residence and/or place of business. These systems, generally termed Competitive Local Exchange Carriers (CLECs), can provide services, which are equivalent to those now available from Regional Bell Operating Companies (RBOCs) over the conventional Plain Old Telephone Service (POTS) copper-pair wiring. In accordance with on aspect of the present invention, a customer will be able to choose to subscribe to both a RBOC and a CLEC, to minimize the time the customer loses telephone service due to power, equipment or network outages, or to optimize the service offerings against pricing from multiple providers. The present invention acts as a collection and distribution point for services available from both providers.

It is to be understood that the present invention is applicable to any system for providing telecommunication services through telephone, set top boxes, computers, satellite links, etc. The present invention is described in terms of an illustrative network(s); however, the concepts of the present invention may be extended to any cable, wireless, optical, hybrids or other network types. For example, the present invention may be practiced between a plurality of heterogeneous networks including cable, cellular, optical, hybrid, POTS, etc. In addition the networks can be digital or analog and may be owned and operated by different entities.

It should be further understood that the elements shown in the FIGS. may be implemented in various forms of hardware, software or combinations thereof. Preferably, these elements are implemented in hardware on one or more appropriately programmed general-purpose devices, which may include a processor, memory and input/output interfaces. Details of the individual block components making up the system architecture are known to skilled artisans, and will only be described in details sufficient for an understanding of the present invention.

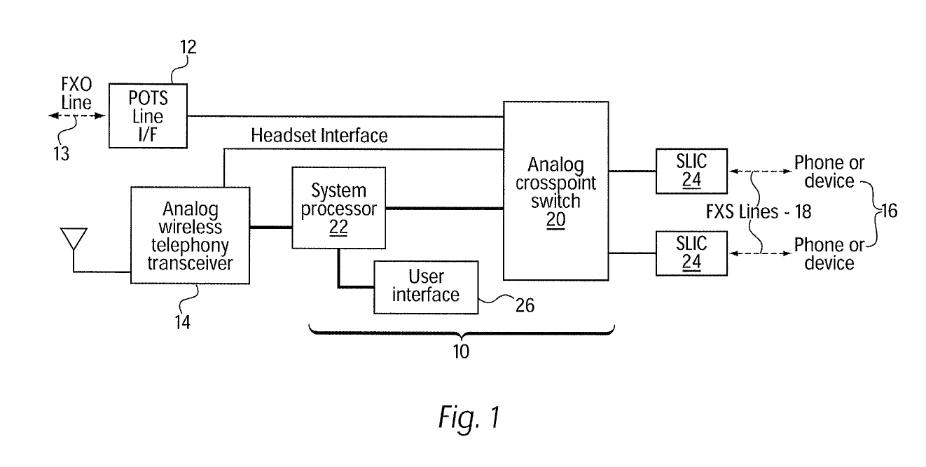

Referring now in specific detail to the drawings in which like reference numerals identify similar or identical elements throughout the several views, and initially to FIG. 1, an illustrative bridge device 10 is shown in accordance with one embodiment of the present invention. Bridge 10 connects to one analog Foreign Exchange Office (FXO) 13 via POTS line 12, an analog wireless telephony service 14 (such as cellular), and two standard analog telephones 16 via Foreign Exchange Station (FXS) interfaces 18. Transceiver 14 may be implemented as a cradle, which holds a standard cellular telephone and provides an analog voice connection to 20 and a control interface to processor 22. From the standpoint of device 10, an FXO interface 12 accepts dial tone, and an FSX interface 24 provides dial tone. Interface 12 is coupled to FXO line 13, and interface 24 is coupled to FSX line 18. All analog signals are combined and gated to other endpoint devices or telephony services by an analog crosspoint switch 20, whose operation is controlled by a system processor 22.

Subscriber Line Interface Circuits (SLICs) 24 drive standard telephones or other analog endpoint devices, supplying dial tone, ringing, and speech signals. A user interface 26 is provided which permits a customer to configure device 10 to enable functions such as preferred outgoing service network, auto-forwarding, multi-line conferencing, etc. In the system of FIG. 1, calls coming in from one service may be routed to a programmed local endpoint device or to the other service network. For example, calls originating from corded telephones (16) or from a wireless telephone (16) may be routed to another local endpoint device (e.g., telephone or other device) or to either service network (e.g., the analog network (POTS) or the wireless network). DTMF tones for dialing are preferably generated by system processor 22.

System processor 22 may be located remotely from a subscriber's location at a central office or other service provider access location, but preferably is located near and controlled by the subscriber to provide independence from service providers. System processor 22 may be employed to enter subscriber specific information (through for example, user interface 26) such as routing information and service subscriptions to enable communication between service provider networks and end point devices. System processor 22 may be a special-purpose device or may be an application program running on a general-purpose device such as a personal computer, which connects to another device to provide telephony hardware interfaces. System processor 22 includes one or more software programs for analyzing system usage and prioritizing calls according to programmed criteria. For example, interface 26 permits a subscriber's information to be associated with a plurality of different networks for different services. In addition, services provided at the system processor 22 may be selected for a particular subscriber based on criteria stored in processor 22 and entered at interface 26. In this way, a subscriber may be automatically connected to a particular service provider network for a particular service being sought. Alternately, the subscriber may be prompted in real-time to make a service provider network selection by entering digits on an attached telephone or adjunct device 16.

In accordance with the present invention, bridge device 10 connects to at least two heterogeneous telephone networks, which may include two or more of a POTS network, cellular network, HFC cable network, DSL network, and/or MMDS/LMDS (Multipoint Microwave Distribution System/Local Multipoint Distribution System) network. Device 10 preferably connects to one or more subscriber endpoint devices, which may include telephones, caller ID displays, facsimile machines, personal digital assistants, analog data modems, Teletypes device for the deaf (TTY), automated billing device, videophones, etc.

Device 10 permits acceptance of a call or message from any of the two or more networks and routes it to any or all appropriate connected endpoint devices. Routing is controlled by system processor 22 and implemented by switch 20. In addition, device 10 can accept a call or message from any of the connected networks and route it to another network by dialing a programmed number (stored in processor 22 and input at user interface 26) and establishing a connection. One illustrative use of this feature may include routing calls from all networks to a common auto-attendant or voice mail system. Another example may provide an auto-forwarding system that does not require special services from a network provider.

Device 10 includes the capability to process dialed digits from any connected endpoint device and route a call to a best choice of network, based on rate lookup Least-Cost Routing (LCR), best Quality of Service (QoS), time of day or other algorithms. A call placed from an endpoint such as a telephone is checked at system processor 22 to determine if a user preference has been entered. The user preference is employed to determine the best routing for the call (e.g., Least-Cost Routing (LCR), best Quality of Service (QoS), time of day, etc.). These choices may be provided automatically or in accordance with a weighting system, for example, weighting cost highest before quality or any combination of service criteria.

Bridge device 10 may include a fail-safe mode, by which in the event of loss or operating power to device 10 or other operational failure of device 10, a relay in switch 20 completes a path between at least one endpoint device and the POTS network to continue telephone service. Bridge device 10 may also include the capability to process calls on at least two networks simultaneously and combine the speech signals so as to enable conference calls between the networks without requiring special services from either network provider. Other services and features may also be provided in accordance with the present invention.

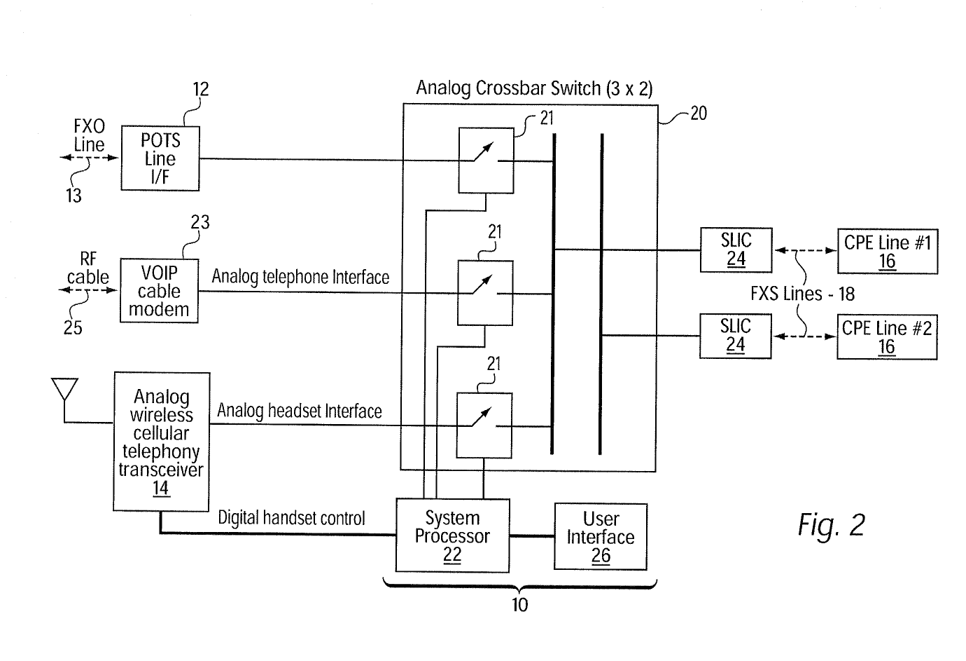

Referring to FIG. 2, for small systems, device 20 may be implemented as a set of relays 21 to provide a two-wire (tip and ring) interconnection between a desired analog network (e.g., POTS line 12) and a desired analog Customer Premise Equipment (CPE) device 16. FIG. 2 illustratively shows interconnection between three networks and two SLICs 24. The three networks in this example include an analog network connected to line 12, a VoIP/cable modem network connected to a modem 23 by an RF cable 25. and a cellular network connected to transceiver 14.

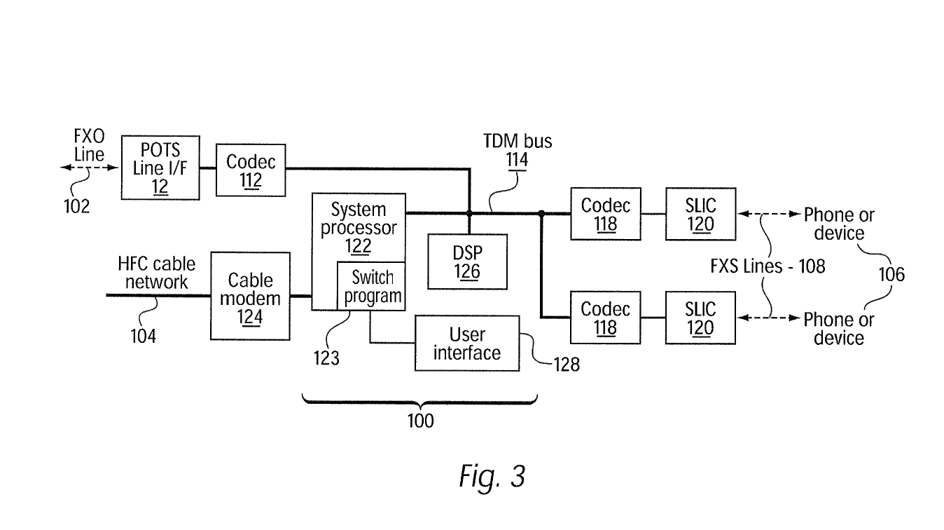

Referring to FIG. 3, a digital bridge device 100 is shown which connects to one analog FXO line 102, HFC cable telephony service 104, and two standard analog telephones 106 via FSX lines 108. Data is sampled from a POTS network 110 using a coder-decoder (codec) 112. The codec 112 drives data onto the shared Time-Division Multiplexed (TDM) bus 114 during its assigned time slot. Similarly, codec 112 reads data from the TDM bus 114 during its assigned time slot. Additional codecs 118 each connect to a Subscriber Line Interface Circuit (SLIC) 120, which drives a telephone or other analog endpoint device, supplying dial tone, ringing, and speech signals. The codecs 118 on the telephone side also write to and read from the TDM bus 114. A system processor 122 reads and writes digital signals from a cable modem 124 and converts the voice data streams into the proper format for the TDM bus 114. A Digital Signal Processor (DSP) 126 reads data from the TDM bus's multiple slots, performs summing and filtering operations, and drives the resulting data onto the TDM bus 114 during the appropriate time slots, under control of the system processor 122.

A user interface 128 permits the customer to configure the device and to enable extended functions. For example, interface 128 permits a subscriber's information to be associated with a plurality of different networks for different services. In addition, services provided at the system processor 122 may be selected for a particular subscriber based on criteria stored in processor 122 and entered at interface 128. In this way, a subscriber may be automatically connected to a particular service provider network for a particular service being sought. Alternately, the subscriber may be prompted in real-time to make a service provider network selection by entering digits on the telephone or adjunct device 106.

System processor 122 may be located remotely from a subscriber's location at a central office or other service provider access location, but preferably is located near and controlled by the subscriber in order to provide independence from service providers. System processor 122 may be employed to enter subscriber specific information (through for example, user interface) such as routing information and service subscriptions to enable communication between service provider networks and end point devices, as described above with reference to FIG. 1. System processor 122 includes one or more software programs for analyzing system usage and prioritizing calls according to programmed criteria.

In accordance with the present invention, bridge device 100 connects to at least two heterogeneous telephone networks, which may include two or more of a POTS network, cellular network, HFC cable network, DSL network, and/or MMDS/LMDS network. Device 100 preferably connects to one or more subscriber endpoint devices, which may include telephones, caller ID displays, facsimile machines, analog data modems, videophones, etc. Device 100 permits acceptance of a call or message from any of the two or more networks and routes it to any or all appropriate connected endpoint devices. Routing in digital networks is controlled by system processor 122, and in particularly a switching program 123. In addition, device 100 can accept a call or message from any of the connected networks and route it to another network by dialing a programmed number (stored in processor 122 and input at user interface 128) and establishing a connection. One illustrative use of this feature may include routing calls from all networks to a common auto-attendant or voice mail system. Another example may provide an auto-forwarding system that does not require special services from a network provider.

Device 100 includes the capability to process dialed digits from any connected endpoint device and route a call to a best choice of network, based on rate lookup Least-Cost Routing (LCR), best Quality of Service (QoS), time of day or other algorithms. A call placed from an endpoint such as a telephone is checked at system processor 122 to determine if a user preference has been entered. The user preference is employed to determine the best routing for the call (e.g., Least-Cost Routing (LCR), best Quality of Service (QoS), time of day, etc.). These choices may be provided automatically or in accordance with a weighting system, for example, weighting cost highest before quality or any combination of service criteria.

Bridge device 100 may include a fail-safe mode, by which in the event of loss or operating power to device 100 or other operational failure of device 100, a virtual relay in processor 122 completes a virtual circuit path between at least one endpoint device and the POTS network to continue telephone service. Bridge device 100 may also include the capability to process calls on at least two networks simultaneously and combine the speech signals so as to enable conference calls between the networks without requiring special services from either network provider. Other services and features are contemplated may also be provided in accordance with the present invention.

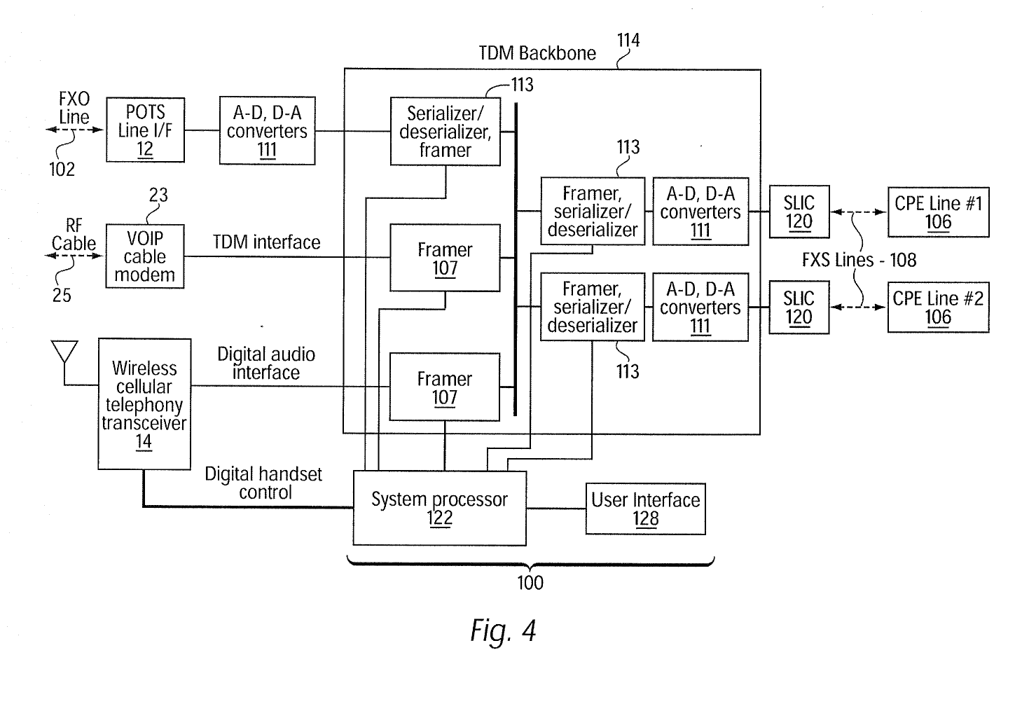

Referring to FIG. 4, for more complex systems, functions of device 20 (FIGS. 1 and 2) could be implemented similarly as a PBX, with a Time-Division Multiplexed (TDM) bus 114 whose framing is controlled by device 122. User interface 128 (or 26) presents the subscriber with possible choices for available network connections and CPE ports 106 (e.g., lines #1 or #2). A possible implementation would be a Hypertext Markup Language (HTML) form presented to a terminal connected to system processor 122. This form would prompt the user for selection of service providers, routing criteria, the number, type and port assignments of CPE devices, etc.

TDM backbone 114 includes hardware and software needed to implement the proper switching capability between analog-to-digital conversions performed by Analog-Digital (A-D) and Digital-Analog (D-A) converters 111. Framers 107 and Serializer/Deserializer's 113 are employed to ensure compatibility between protocols, encoding and encryption between the networks and the end-points for the subscriber. Functions and operations of backbone 114 are preferably controlled in accordance with system processor 122.

Having described preferred embodiments for bridge between multiple telephone service providers (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

1. A bridge device for telephony services, comprising:
a system processor coupled between at least two heterogeneous telephone networks, the system processor including information for selecting one of the heterogeneous networks in accordance with criteria; and
a switching device controlled by the system processor to dynamically select one of the at least two heterogeneous telephone networks to provide service to a subscriber by causing a connection to be made to the selected telephone network.

2. The bridge device as recited in claim 1, wherein the at least two heterogeneous networks include at least one of plain old telephone service (POTS), cellular, hybrid fiber coaxial (HFC) cable, Digital Subscriber Line (DSL), and Multipoint Microwave Distribution System/Local Multipoint Distribution System(MMDS/LMDS).

3. The bridge device as recited in claim 1, wherein the switch connects a plurality of subscriber endpoint devices.

4. The bridge device as recited in claim 3, wherein the endpoint devices include at least one of a telephone, a caller identification display, a facsimile machine, an analog data modem, a Teletype device for the deaf (TTY), a personal digital assistant, an automated billing device, and a videophone.

5. The bridge device as recited in claim 1, wherein the switching device accepts a call or message from any of the at least two heterogeneous networks and routes the call or message to predetermined connected endpoint devices.

6. The bridge device as recited in claim 1, wherein the system processor accepts a call or message from any of the at least two heterogeneous networks and routes the call or message to a different network by dialing a number programmed in the system processor to establish a connection to the different network.

7. The bridge device as recited in claim 1, wherein the criteria includes dialed digits entered by a subscriber from any connected endpoint device such that a call is routed to one of the at least two heterogeneous networks based on the dialed digits.

8. The bridge device as recited in claim 1, wherein the criteria includes one of a choice of network based on at least one of rate lookup Least-Cost Routing (LCR), Quality of Service (QoS), and time of day.

9. The bridge device as recited in claim 1, wherein one of the heterogeneous networks includes a plain old telephone service (POTS) network and the switch includes a relay which completes a path between at least one endpoint device and the POTS network as a fail-safe mode in the event of loss of operating power.

10. The bridge device as recited in claim 1, wherein the system processor processes calls on at least two networks simultaneously and combines speech signals to enable conference calls between the networks.

11. The bridge device as recited in claim 1, further comprising a user interface coupled to the system processor for setting the criteria for individual subscribers.

12. A bridge device for telephony services, comprising:
a system processor coupled between at least two heterogeneous telephone networks, one of the at least two heterogeneous telephone networks for processing digital signals thereon, the system processor including information for selecting one of the heterogeneous networks in accordance with criteria; and
the switching processor including a switching program controlled by the system processor to dynamically select one of the at least two heterogeneous telephone networks to provide service to a subscriber by causing a connection to be made to the selected telephone network.

13. The bridge device as recited in claim 12, wherein the at least two heterogeneous networks include at least one of plain old telephone service (POTS), cellular, hybrid fiber coaxial (HFC) cable, Digital Subscriber Line (DSL), and Multipoint Microwave Distribution System/Local Multipoint Distribution System (MMDS/LMDS).

14. The bridge device as recited in claim 12 wherein the system processors connects a plurality of subscriber endpoint devices by a time-division multiplexed bus.

15. The bridge device as recited in claim 14, wherein the endpoint devices include at least one of a telephone, a caller identification display, a facsimile machine, an analog data modem, a Teletype device for the deaf (TTY), a personal digital assistant, an automated billing device and a videophone.

16. The bridge device as recited in claim 12, wherein the switching program accepts a call or message from any of the at least two heterogeneous networks and routes the call or message to predetermined connected endpoint devices.

17. The bridge device as recited in claim 12, wherein the system processor accepts a call or message from any of the at least two heterogeneous networks and routes the call or message to a different network by dialing a number programmed in the system processor to establish a connection to the different network.

18. The bridge device as recited in claim 12, wherein the criteria includes dialed digits entered by a subscriber from any connected endpoint device such that a call is routed to one of the at least two heterogeneous networks based on the dialed digits.

19. The bridge device as recited in claim 12, wherein the criteria includes one of a choice of network based on at least one of rate lookup Least-Cost Routing (LCR), Quality of Service (QoS), and time of day.

20. The bridge device as recited in claim 12, wherein the system processor processes calls on at least two networks simultaneously and combines speech signals to enable conference calls between the networks.

21. The bridge device as recited in claim 12, further comprising a user interface coupled to the system processor for setting the criteria for individual subscribers.
